(19) United States
(12) Patent Application Publication
(10) Pub. No.: US 2014/0046816 A1
(43) Pub. Date: Feb. 13, 2014

(54) Methods and Systems for Managing Cardholder Spending

(71) Applicants: Mishez Avari, Rolling Meadows, IL (US); Andrew Eric Ziesmer, St. Charles, IL (US)

(72) Inventors: Mishez Avari, Rolling Meadows, IL (US); Andrew Eric Ziesmer, St. Charles, IL (US)

(73) Assignee: CITIGROUP CREDIT SERVICES, INC., Long Island, NY (US)

(21) Appl. No.: 13/569,249

(22) Filed: Aug. 8, 2012

(51) Int. Cl. G06Q 40/02

(52) U.S. Cl. 705/35

(57) ABSTRACT

Methods and systems for managing cardholder spending on a transaction card account employ a processor coupled to memory and other computer hardware and software components to receive a monthly spending budget for a cardholder, track expenditures of the cardholder in a current month against the monthly spending budget, and adjust the monthly spending budget for a succeeding month when expenditures exceed a credit limit of the cardholder. The adjustment may be made according to an order of a predetermined prioritization of a plurality of budget categories or by a proportional amount in each of the plurality of budget categories in the absence of a predetermined prioritization.

### FIELD OF THE INVENTION

The present invention relates generally to the field of transaction cards and more particularly to methods and systems for managing cardholder spending on a transaction card account.

### BACKGROUND OF THE INVENTION

During the pre-recession years, there may have been little reason or incentive for many consumers to work within a fixed budget. Credit was easily available allowing people to spend more freely and live more lavish lifestyles than their core income may have allowed. However, economic changes in the U.S. and elsewhere in recent years may have contributed to a growing awareness by consumers of a compelling need to create a sustainable budget and adhere to that budget. Consumers may avail themselves with the assistance of financial planners to help in the budget process, but the cost of working with financial planning professionals is relatively high. Typically, consumers who most need help in budgeting cannot afford the cost of a financial planner. There is a current need for a method and system for managing cardholder spending on a transaction card account that is affordable and easy to use that can help consumers develop a budget and stick to that budget.

### SUMMARY OF THE INVENTION

Embodiments of the invention employ computer hardware and software, including, without limitation, one or more processors coupled to memory and non-transitory computer-readable storage media with one or more executable programs stored thereon which instruct the processors to perform the methods and systems for managing cardholder spending on a transaction card account described herein.

Embodiments of the invention may provide methods for managing cardholder spending that involve, for example, receiving, using a processor coupled to memory, a monthly spending budget for a cardholder, tracking, using the processor, expenditures of the cardholder in a current month against the monthly spending budget, and adjusting, using the processor, the monthly spending budget for a succeeding month when expenditures exceed a credit limit of the cardholder. According to embodiments of the invention, the adjustment is made according to an order of a predetermined prioritization of a plurality of budget categories or by a proportional amount in each of the plurality of budget categories in the absence of a predetermined prioritization.

In aspects of embodiments of the invention, receiving the monthly spending budget may involve, for example, receiving the monthly spending budget for the cardholder in each of a plurality of budget categories. In such aspects, receiving the monthly spending budget in each of the plurality of budget categories may involve, for example, receiving the monthly spending budget in each of the plurality of budget categories corresponding to predefined card association merchant category codes. Also, in such aspects, receiving the monthly spending budget in each of the plurality of budget categories may involve, for example, receiving a prioritization of the plurality of budget categories when a total spend of the cardholder for the current month exceeds the credit limit of the cardholder.

In other aspects of embodiments of the invention, receiving the monthly spending budget may involve, for example, receiving the monthly spending budget equal to or less than a credit line of the cardholder. In further aspects, receiving the monthly spending budget may involve, for example, receiving the monthly spending budget by a budget program database via a communication platform and a web interface. In such aspects, receiving the monthly spending budget may involve, for example, receiving the monthly spending budget via a setup screen of the web interface prepopulated with recommended budget figures corresponding to a cardholder's level of annual income. In additional aspects, receiving the monthly spending budget may involve, for example, receiving an election for email or text message notification to the cardholder when a total spend of the cardholder for the current month reaches a predetermined threshold. In still other aspects, receiving the monthly spending budget may involve, for example, receiving an election for transactions to be declined that exceed the monthly spending budget for the current month.

In further aspects of embodiments of the invention, tracking expenditures of the cardholder in the current month may involve, for example, allowing all expenditures of the cardholder in a current month up to the monthly spending budget. In such aspects, tracking expenditures in the current month may involve, for example, tracking expenditures of the cardholder in the current month against the monthly spending budget in each of the plurality of budget categories. Additionally in such aspects, tracking expenditures in the current month against the monthly spending budget in each of the plurality of budget categories may involve, for example, tracking the expenditures in the current month against the monthly spending budget in each of the plurality of budget categories prioritized in the event a total spend of the cardholder for the current month exceeds the credit limit of the cardholder.

In additional aspects, tracking expenditures in the current month against the monthly spending budget in each of a plurality of budget categories may involve, for example, notifying the cardholder when at total spend of the cardholder reaches a predetermined threshold. In still further aspects, tracking expenditures in the current month against the monthly spending budget in each of a plurality of budget categories further comprises declining transactions that exceed the monthly spending budget for the current month. In other aspects, tracking expenditures in the current month against the monthly spending budget in each of a plurality of budget categories may involve, for example, declining transactions based on the predetermined prioritization of the plurality of budge categories when a total spend of the cardholder for the current month exceeds the monthly spending budget.

In still other aspects, adjusting the monthly spending budget for the succeeding month when expenditures exceed the credit limit of the cardholder may involve, for example, adjusting the spending budget by a shortfall amount according to the order of the predetermined prioritization of the plurality of budget categories. In further aspects, adjusting the spending budget by the shortfall amount according to the order of the predetermined prioritization of the plurality of budget categories may involve, for example, adjusting the spending budget by the shortfall amount to accommodate category budgets in the order of the predetermined prioritization of the plurality of budget categories.

In further aspects of embodiments of the invention, adjusting the monthly spending budget for the succeeding month when expenditures exceed the credit limit of the cardholder may involve, for example, adjusting the spending budget in each of the plurality of budget categories by a proportion of a shortfall in the absence of a predetermined prioritization. In other aspects, adjusting the spending budget in each of the plurality of budget categories by a proportion of a shortfall in the absence of a predetermined prioritization may involve, for example, adjusting each of the plurality of budget categories by a percentage equal to the shortfall percentage.

Additional embodiments of the invention may provide systems for managing cardholder spending on a transaction card account that employs, for example, a processor coupled to memory, which processor is programmed, for example, to receive a monthly spending budget for a cardholder, track expenditures of the cardholder in a current month against the monthly spending budget, and adjust the monthly spending budget for a succeeding month when expenditures exceed a credit limit of the cardholder. The processor is further programed, for example, to make such adjustment according to an order of a predetermined prioritization of a plurality of budget categories or by a proportional amount in each of the plurality of budget categories in the absence of a predetermined prioritization.

These and other aspects of the invention will be set forth in part in the description which follows and in part will become more apparent to those skilled in the art upon examination of the following or may be learned from practice of the invention. It is intended that all such aspects are to be included within this description, are to be within the scope of the present invention, and are to be protected by the accompanying claims.

### BRIEF DESCRIPTION OF THE DRAWINGS

FIG. 1 is a schematic diagram that shows an overview example of key components and the flow of information between key components for embodiments of the invention;

FIG. 2 illustrates an example of a setup screen for embodiments of the invention;

FIG. 3 is a table that illustrates an example of the cardholder's category budget amounts accommodated in order of priority up to an amount of the cardholder's open line for embodiments of the invention;

FIG. 4 is a table which illustrates an example of reduction of the cardholder's unprioritized budget when the cardholder does not have enough open line to accommodate his or her budget; and

FIG. 5 is a flow chart that illustrates an example of the process of managing cardholder spending on a transaction card account for embodiments of the invention.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For example, features illustrated or described as part of one embodiment can be used in another embodiment to yield a still further embodiment. Thus, it is intended that the present invention cover such modifications and variations that come within the scope of the invention.

Embodiments of the invention provide methods and systems for credit card budget management. Embodiments of the invention provide a budgeting tool for consumers which enables consumers to set up monthly budgets and manage those budgets with the help of their credit card account. Aspects of the invention may provide a card association bankcard that is accepted in the same way as any other card association bankcard while enabling the cardholder to stay within his or her budget for a fraction of the cost of a financial planner. In embodiments of the invention, when a potential cardholder is approved for the card, he or she may set up a monthly budget that is less than the cardholder's credit line.

Once such a budget is set up, all transactions with the cardholder's credit card up to the amount of the monthly budget may be allowed if the customer has asked for transactions to be limited up to the monthly budget. Transactions up the credit line may be allowed, if the customer has not requested that transactions stop once the monthly budget has been reached. Thus, embodiments of the invention enable cardholders to set up a total monthly budget which they can manage. In embodiments of the invention, the cardholder may also set up individual category monthly budgets, such as $500 per month for groceries, $300 per month for utilities, $250 per month for entertainment and have the transactions in each of those categories tracked. According to embodiments of the invention, the budget categories and subcategories may correspond, for example to card association merchant category codes, and cardholders may choose to populate as many or as few category and/or subcategory budgets as they wish.

An aspect of the functionality for embodiments of the invention may enable cardholders to prioritize one or more of the cardholders' category budgets. In the prioritizing aspect, if a cardholder does not have enough line open to accommodate the cardholder's entire monthly budget, the cardholder may prioritize certain categories so that transactions in those categories that are prioritized higher may be allowed to proceed first on the monthly budget before any of the cardholder's lower priority categories are allowed to proceed. If the cardholder has an open line sufficient for the cardholder's entire monthly budget, the prioritizing aspect may not be needed. In that case, the entire monthly budget as specified by the cardholder may be allowed to proceed.

In another aspect of embodiments of the invention, the cardholder may also elect to be notified when a spend threshold is reached such as a spend in a particular category that is within a certain amount of the cardholder's budget or one or more of the category budgets during the current month. In addition, if the cardholder elects to receive notifications, he or she may be notified of new limits and may also be notified when the new category limits are reached. In the notification aspect, when the cardholder is given such notification, he or she may be given an option to choose whether or not to continue to transact in the particular category or categories to which the notification pertains. In further aspects of the invention, the cardholder may elect to have transactions with the card declined when they extend spending beyond the cardholder's category budget and/or the cardholder's total budget.

In embodiments of the invention, an applicant may apply for a bankcard, for example, online. In the application process, an applicant's email address may be a required field. Further, standard bankcard risk and application criteria may be leveraged to determine an applicant's ability to obtain a bankcard. Once an application is approved, an account number may be assigned and the cardholder may be provided with the web address of a webpage on which to set up the cardholder's account online.

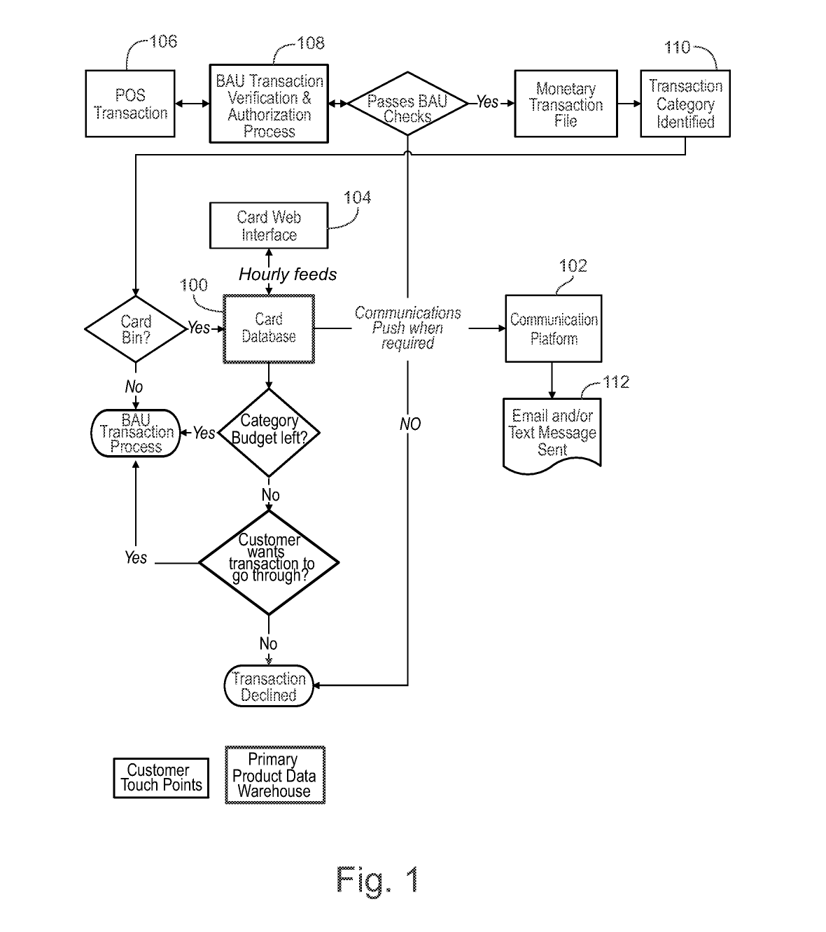

FIG. 1 is a schematic diagram that shows an overview example of components and the flow of information between components for embodiments of the invention. Referring to FIG. 1, embodiments of the invention may employ, for example, a budget program database 100 coupled to a communication platform 102 and a web interface 104. Cardholder touchpoints may include, for example, a merchant point-of-sale terminal 106 or online via the web interface 104. In addition, transaction-processing components, such as a verification and authorization process 108 and category identification process 110 may also be employed.

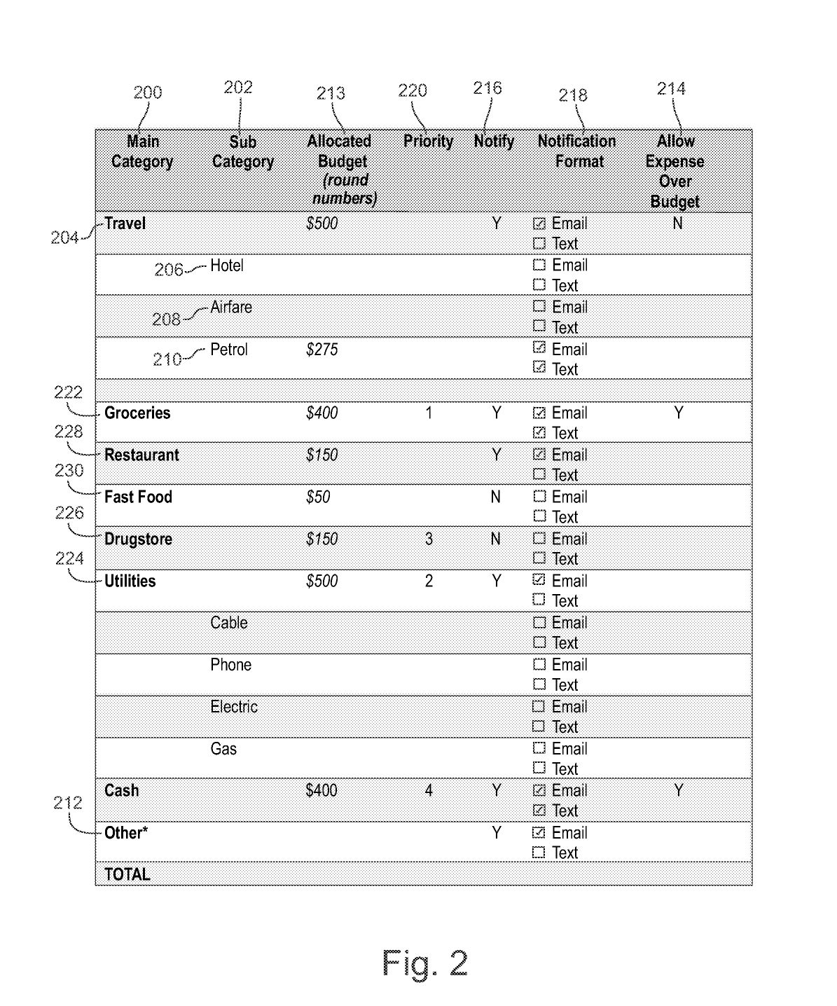

A cardholder may go online via the web interface 104 to a website and set up specifics of the cardholder's category budgets. When the cardholder logs on the designated webpage for embodiments of the invention, he or she may be presented with a setup screen. FIG. 2 illustrates an example of a setup screen for embodiments of the invention. Referring to FIG. 2, the setup screen may have categories 200 that are pre-populated for the cardholder based, for example, on predetermined categories, such as existing category codes currently in use by one or more of the major card associations. In an aspect of embodiments of the invention, within the main categories 200, there may also be subcategories 202. For example, under a category for travel 204, a cardholder may also have subcategories for hotel 206, airfare 208, and gas expenses 210. The cardholder may choose to allocate the cardholder's budget based on a main category 200, a subcategory 204, or some combination of the two.

Referring further to FIG. 2 the “Other” category 212 may include, for example, anything that does not fall into a cardholder-selected category, including any credit card fees and interest charges. The cardholder may be prompted to enter an election to set up a monthly budget, and if he or she declines, the cardholder's credit line may be the default. On the other hand, it the cardholder sets up a monthly budget and declines to set up category budgets, the cardholder's monthly budget may be the default.

The cardholder may also be prompted with an option to input his or her annual income, based upon which the setup screen may be prepopulated with recommended budget figures corresponding to the cardholder's level of income. Thus, the cardholder's category budgets may be prepopulated according to average category budgets for cardholders in the same income bracket. For example, a cardholder may enter his or her annual income, such as $75,000 per year, and computer logic may prepopulate category budgets for the cardholder based on that income. Such prepopulation may, for example, serve only as a guideline or starting point for the cardholder, and he or she may choose to input his or her own allocated budget numbers 213 in each category. Thus, the cardholder may change any or all of the prepopulated category budgets or leave them as is.

In aspects of the invention, the cardholder may be prompted for entry of an action to be taken when the cardholder's spend reaches the cardholder's monthly and / or category budget. For example, the cardholder may be offered options to allow category transactions to proceed to the amount of the cardholder's credit line or to allow category transactions to proceed up to the amount of the cardholder's monthly budget. The cardholder may be offered an option to allow category transactions to proceed over the category budget 214. Absent a selection by the cardholder, the default may be to allow transactions to proceed up to credit line.

In other aspect of embodiments of the invention a cardholder may choose not to set up categories or category budgets. In such an aspect, the cardholder may elect to set up a monthly budget of a particular amount, and all transactions may be allowed up to the amount of that monthly budget. Further, the cardholder may elect to receive notice 216 by email or text message notification 218 when the cardholder's total spend for the month reaches a certain threshold. Additionally, the cardholder may also elect to have transactions declined that are above the amount of that total monthly budget, even if no specific category budgets are specified by the cardholder.

In a further aspect, the cardholder may be given an option to have further credit card transactions declined when certain spend thresholds are reached. For example, a cardholder whose category budget for travel is $500 may elect to have further credit card transactions in the travel category declined when the cardholder's spend in the travel category reaches $500. For another example, the cardholder may be offered options to have transactions declined if they exceed the cardholder's monthly budget by more than a certain amount, such as $10, or to have transactions declined if they exceed the cardholder's category budget by more than that amount. Absent a selection, the default may be to allow transactions to proceed up to the monthly budget or credit line, depending on what may have been set up by the cardholder.

Referring again to FIG. 2, in additional aspects of the invention, the cardholder may be prompted to set up budget category priorities 220. If the cardholder elects to prioritize his or her budget categories 200, when the cardholder's credit line is not sufficient to accommodate the cardholder's full monthly budget, transactions within the higher prioritized categories will be allowed to proceed and those in lower priority categories will be denied. An objective of the prioritization feature is to furnish the cardholder an opportunity to prioritize the cardholder's category budgets 213 so that in the event the cardholder's credit line cannot accommodate the cardholder's entire monthly budget, the cardholder may preselect which budget categories are the most important to the cardholder. Thus, the cardholder may preselect one or more particular budget categories 213 which the cardholder does not consider to involve discretionary spend and have only transactions in such category or categories proceed if the cardholder's credit line cannot accommodate all of the categories in the cardholder's monthly budget.

Assume, for example, that the cardholder preselects a groceries category budget 222 of $400 as a first priority, a utilities category budget 224 of $500 as a second priority, and a drug store category budget 226 of $150 as third priority. Assume also that the cardholder does not assign any prioritization to category budgets for travel 204, restaurant 228, or fast food 230 categories. In such example, if the cardholder does not have sufficient credit line to accommodate all of the monthly category budgets 200, in the payment hierarchy aspect, grocery transactions 222 may be allowed to proceed up to $400 if the cardholder has enough line to accommodate that amount. In addition utilities transactions 224 may be allowed to proceed up to $500 and drugstore purchases 226 may be allowed to proceed up to $150 likewise if the cardholder has enough line to accommodate that amount. Charges in all other budget categories may be declined unless the cardholder has enough credit line open to accommodate such charges. Thus, the cardholder's remaining credit line may be left open in order to accommodate transactions which the cardholder identifies as being the cardholder's core or critical categories.

If the cardholder does not elect to prioritize his or her budget categories, transactions may be allowed to proceed on a first-come-first-served basis until the cardholder's open line or budget is exhausted. In other aspects, the cardholder may be prompted to set up notification options 216, for example, at main category 200 or subcategory 202 levels. For example, the cardholder may be offered an option to be notified if his or her spend is within a specified amount, such as $10 or $50, of the budget set up by the cardholder. Thus, a cardholder who sets a $500 per month travel budget may elect to be notified if and when the cardholder's spend reaches $450 in the travel category within a particular month.

While the default notification method 218 may be email, the cardholder may also enter a selection of either or both of email and text message notification. If the cardholder elects text message notification, he or she may also be prompted to provide a mobile phone number and to acknowledge that standard carrier texting charges may apply. In the notification aspect, if the cardholder requests notification, he or she may be notified when there is $50 remaining in the cardholder's category/monthly budget and again when the monthly/category budget has been exhausted.

In the aforementioned prioritization aspect, the cardholder may prioritize his or her budget categories, for example, when the cardholder does not have sufficient open line to accommodate a particular month's budget. Thus, if the cardholder does not have enough open line for his or her entire monthly budget, the remaining line may be retained for expenditures which the cardholder may perceive to be more ‘critical’ budget items. However, if the cardholder does not choose to prioritize his or her budget, all charges on his or her bankcard may be allowed to proceed until such time as other limits on the card, such as monthly category budget, total monthly budget, or total open line, have been reached.

On the other hand, if the cardholder elects to prioritize his or her budget categories, when the cardholder does not have enough line to cover his or her entire monthly budget, the amount of the cardholder's remaining line may be calculated and allocated to budget categories according to the cardholder's identified priorities regardless of the cardholder's other selections. Assume, for example, that the cardholder elects to prioritize budget categories and requests that transactions be declined when his or her budget is reached. If the cardholder has sufficient open line to accommodate his or her budget, there is no impact at all on the succeeding month's budget. Even if the cardholder does not elect to prioritize budget categories and requests that transactions be declined when his or her budget is reached, if the cardholder has sufficient open line to accommodate his or her budget, there is likewise no impact on the succeeding month's budget.

On the other hand, if the cardholder elects to prioritize budget categories and requests that transactions be declined when his or her budget is reached but does not have enough open line to accommodate his or her budget, the balance may be billed to the cardholder at the base annual percentage rate with finance charges allocated to the “Other” budget category 212. In such case, the cardholder's current month's budget may accommodate all the cardholder's category budgets in order of priority up to the amount of the cardholder's open line. For example, if the cardholder has an open line of $950 and a budget of $1,500, all categories in order of priority up to $950 of the cardholder's total budget may be accommodated.

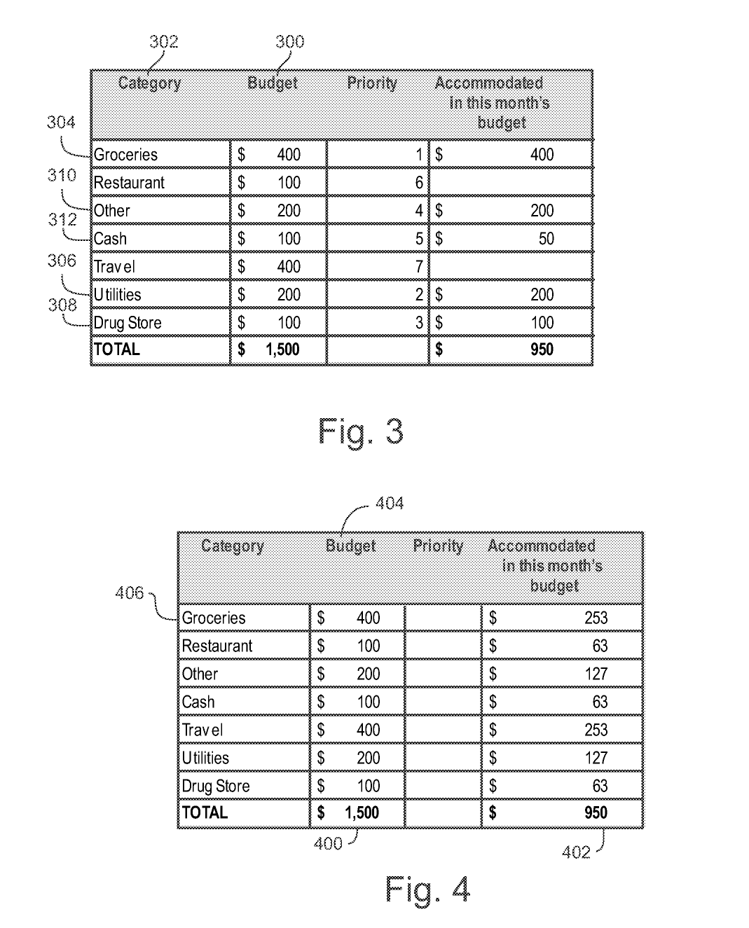

FIG. 3 is a table that illustrates an example of the cardholder's category budget amounts accommodated in order of priority up to an amount of the cardholder's open line for embodiments of the invention. For example, referring to FIG. 3, assume that a cardholder sets up an initial budget 300 of $1,500 covering seven categories but has an open line of only $950. Assume also that the cardholder prioritizes the seven categories in rankings of one through seven and that the first five category budgets add up to $1,000. If the cardholder asks that all transactions with his or her credit card to be stopped as soon as the amount spent reaches the category budget, once the cardholder's spend with the card reaches $950 in the first five categories that are prioritized, spending with the card will be terminated.

Referring also to FIG. 3, assume further that the cardholder's category budgets 302 are, for example, $400 for groceries 304 as a first priority, $200 for utilities 306 as a second priority, $100 at the drugstore 308 as third priority, $200 for other spending 310 as a fourth priority, and $100 for cash 312 as a fifth priority. It can be seen that the cardholder's total category budget for those five priorities is $1,000 while the cardholder has an open line of only $950. Therefore, the $100 amount of the category budget for cash 312 as the fifth priority number is reduced by $50 to accommodate the cardholder's $950 open line. In that scenario, all first priority grocery transactions 304 in the particular month up to $400 will be allowed to proceed, as will second priority utilities transactions 306 up to $200, third priority drug store transactions 308 up to $100, and fourth priority other transactions 310 up to $200. However, only $50 of the $100 fifth priority cash budget 312 will be allowed to proceed, at which point the cardholder's $950 open line is exhausted.

It is to be understood that if for some reason the cardholder has not spent all of the budgeted money in a particular category budget, the unspent money is not automatically transferred to another category budget. That is because the unspent money in the particular category budget must remain available to the cardholder in order to honor the cardholder's prioritizations. If by the end of the current month the cardholder has not spent the full $950 in the prioritized categories, the open line will move to the succeeding month's budget.

In the event the cardholder has an unpaid credit card balance in a succeeding month, the cardholder may be charged interest on the unpaid balance at a base annual percentage rate. Further, if the cardholder's remaining credit line is not sufficient to accommodate the succeeding month's category budgets, the succeeding month's category budgets may be reduced accordingly. Thus, if the cardholder fails to pay off his or her entire budget, the remaining balance of the open line is used for the succeeding month's budget. That means that the succeeding month's category budgets may be very limited.

In an aspect of embodiments of the invention, if the cardholder's remaining open line in the succeeding month is less than a predetermined amount, such as $500, the entire budgeting and prioritization tool function may be suspended. In that case, the remaining line in the cardholder's credit card account may simply be allowed to function in the same manner as in any regular credit card account in which the open line is applied to transactions on a first-come-first-served basis. Once the line is exhausted, further transactions with the cardholder's card may not be allowed to proceed. It is to be noted that even if “Other” is not prioritized high enough to fit in the budget, any applicable finance and interest charges may still be applied.

As previously noted, the cardholder may elect to prioritize budget categories but not to request that transactions be declined when his or her budget is reached. In such case, if the cardholder does not have enough open line to accommodate his or her budget, the balance may likewise be billed to the cardholder at the base annual percentage rate with finance charges allocated to the “Other” budget category. In this case, the current month's budget may be updated and all category transactions may be allowed to proceed up to the cardholder's open line limit. In addition, if the cardholder elects to receive notifications, he or she may be notified of the new limits and further notified when the new category limits are reached.

Referring again to the example of the cardholder who sets up a total monthly budget of $1,500 but who has an open line of only $950. Assume that the cardholder does not elect to prioritize his or her budget categories and requests that transactions be declined when his or her budget is reached. Because the cardholder's $950 credit line is not sufficient to accommodate his or her $1,500 budget, if the cardholder does not go online to the website to make adjustments to his or her budget, the cardholder's budget for all categories may be automatically reduced by a percentage equal to the percentage of the shortfall in the cardholder's open line.

FIG. 4 is a table which illustrates an example of reduction of the cardholder's unprioritized budget when the cardholder does not have enough open line to accommodate his or her budget. Referring to FIG. 4, since the difference between the cardholder's total monthly budget 400 of $1,500 and the cardholder's credit line 402 of $950 is approximately 37%, the cardholder's category budgets 404 in each separate category may be reduced by 37%. In the foregoing example, if the cardholder has requested that transactions be declined after the category budgets are reached, transactions will be declined after the cardholder's spend reaches the reduced budget amount for the month. Thus, the cardholder's $400 grocery category budget 406 may be reduced by 37% to $253, and the cardholder may be notified when the cardholder's spend in the grocery category reaches, for example, $200.

In this example, when the cardholder's spend in the grocery category reaches $253, further transactions in the grocery category may be declined. However, if the cardholder does not request that transactions in the particular category be declined after the category budget is reached, transactions in that category may continue to be allowed up to the amount of the cardholder's open line. In addition, if the cardholder elects to receive notifications, he or she will likewise be notified of the new limits and further notified when the new category limits are reached. In that case, the cardholder may be sent a notification that the cardholder's spend in the grocery category 406 has reached the $253 budgeted for groceries.

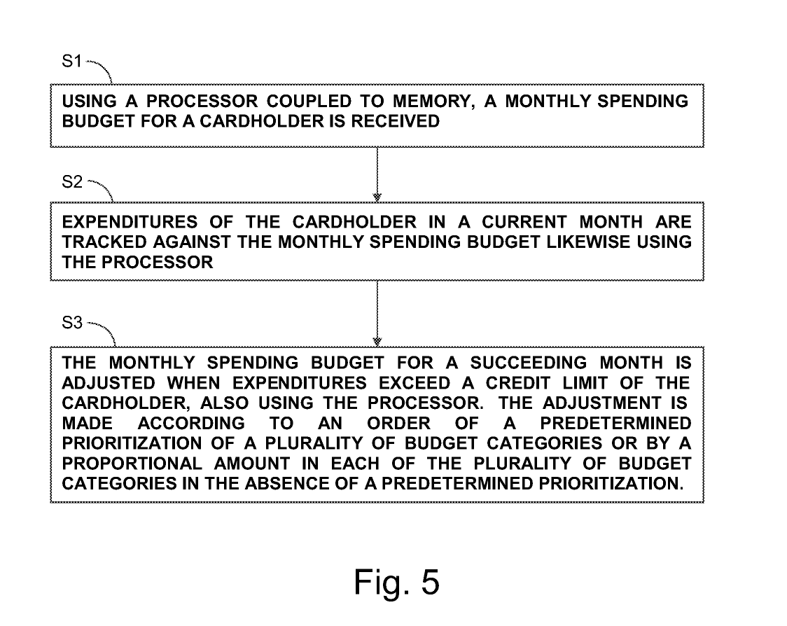

FIG. 5 is a flow chart that illustrates an example of the process of managing cardholder spending on a transaction card account for embodiments of the invention. Referring to FIG. 5, at S1, using a processor coupled to memory, a monthly spending budget for a cardholder is received. At S2, expenditures of the cardholder in a current month are tracked against the monthly spending budget likewise using the processor. At S3, the monthly spending budget for a succeeding month is adjusted when expenditures exceed a credit limit of the cardholder, also using the processor. The adjustment is made according to an order of a predetermined prioritization of a plurality of budget categories or by a proportional amount in each of the plurality of budget categories in the absence of a predetermined prioritization.

In an embodiment of the invention, cardholders may have constant access to the budget program database 100 and may change, for example, any or all of their category budgets from time-to-time. In the event of such changes, there may be a delay of a few hours for the changes to be fully implemented. In that regard, assume that a cardholder currently has, for example, a $400 grocery category budget and has already spent that amount on groceries. If the cardholder thereafter elects to change his or her grocery category budget to $200 in the same month, clearly the change cannot be implemented in the current month.

As previously noted, cardholders may access the budget program database 100 via the web interface 104 for the purpose, for example, of making changes to their budget features. It is to be noted that communication between the cardholder via the web interface 104 and the budget program database 100 is two-way and interactive. Thus, a cardholder may enter information, for example, on the web interface 104, which is then received and stored on the budget program database 100. Likewise, a cardholder who is concerned about the current status of his or her total spend of his or her spend in a particular category may access the budget program database 100 from time-to-time via the web interface 104 to check his or her spend status. Further, when a cardholder reaches a predetermined spend threshold in his or her total spend or his or her spend in a particular category, a communication may be sent from the budget program database 100 to the cardholder via the communication platform 102 by email or text message 112. In addition, during a point-of-sale transaction 106, when a transaction is identified 110, for example, as a category budget transaction, transaction information including a transaction category identifier may be sent to the budget program database 100 for a determination of whether to allow or decline the transaction.

It is to be understood that embodiments of the invention may be implemented as processes of a computer program product, each process of which is operable on one or more processors either alone on a single physical platform, such as a personal computer, or across a plurality of platforms, such as a system or network, including networks such as the Internet, an intranet, a WAN, a LAN, a cellular network, or any other suitable network. Embodiments of the invention may employ client devices that may each comprise a computer-readable medium, including but not limited to, random access memory (RAM) coupled to a processor. The processor may execute computer-executable program instructions stored in memory. Such processors may include, but are not limited to, a microprocessor, an application specific integrated circuit (ASIC), and or state machines. Such processors may comprise, or may be in communication with, media, such as computer-readable media, which stores instructions that, when executed by the processor, cause the processor to perform one or more of the steps described herein.

It is also to be understood that such computer-readable media may include, but are not limited to, electronic, optical, magnetic, RFID, or other storage or transmission device capable of providing a processor with computer-readable instructions. Other examples of suitable media include, but are not limited to, CD-ROM, DVD, magnetic disk, memory chip, ROM, RAM, ASIC, a configured processor, optical media, magnetic media, or any other suitable medium from which a computer processor can read instructions. Embodiments of the invention may employ other forms of such computer-readable media to transmit or carry instructions to a computer, including a router, private or public network, or other transmission device or channel, both wired or wireless. Such instructions may comprise code from any suitable computer programming language including, without limitation, C, C++, C#, Visual Basic, Java, Python, Perl, and JavaScript.

It is to be further understood that client devices that may be employed by embodiments of the invention may also comprise a number of external or internal devices, such as a mouse, a CD-ROM, DVD, keyboard, display, or other input or output devices. In general such client devices may be any suitable type of processor-based platform that is connected to a network and that interacts with one or more application programs and may operate on any suitable operating system. Server devices may also be coupled to the network and, similarly to client devices, such server devices may comprise a processor coupled to a computer-readable medium, such as a random access memory (RAM). Such server devices, which may be a single computer system, may also be implemented as a network of computer processors. Examples of such server devices are servers, mainframe computers, networked computers, a processor-based device, and similar types of systems and devices

1. A method of managing cardholder spending on a transaction card account, comprising:
receiving, using a processor coupled to memory, a monthly spending budget for a cardholder;
tracking, using the processor, expenditures of the cardholder in a current month against the monthly spending budget; and
adjusting, using the processor, the monthly spending budget for a succeeding month when expenditures exceed a transaction card account credit limit of the cardholder, said adjustment being made according to an order of a predetermined prioritization of a plurality of budget categories or by a proportional amount in each of the plurality of budget categories in the absence of a predetermined prioritization.

2. The method of claim 1, wherein receiving the monthly spending budget further comprises receiving the monthly spending budget for the cardholder in each of a plurality of budget categories.

3. The method of claim 2, wherein receiving the monthly spending budget in each of the plurality of budget categories further comprises receiving the monthly spending budget in each of the plurality of budget categories corresponding to predefined card association merchant category codes.

4. The method of claim 2, wherein receiving the monthly spending budget in each of the plurality of budget categories further comprises receiving a prioritization of the plurality of budget categories when a total spend of the cardholder for the current month exceeds exceed the credit limit of the cardholder.

5. The method of claim 1, wherein receiving the monthly spending budget further comprises receiving the monthly spending budget equal to or less than a credit line of the cardholder.

6. The method of claim 1, wherein receiving the monthly spending budget further comprises receiving the monthly spending budget by a budget program database via a communication platform and a web interface.

7. The method of claim 6, wherein receiving the monthly spending budget further comprises receiving the monthly spending budget via a setup screen of the web interface prepopulated with recommended budget figures corresponding to a cardholder's level of annual income.

8. The method of claim 1, wherein receiving the monthly spending budget further comprises receiving an election for email or text message notification to the cardholder when a total spend of the cardholder for the current month reaches a predetermined threshold.

9. The method of claim 1, wherein receiving the monthly spending budget further comprises receiving an election for transactions to be declined that exceed the monthly spending budget for the current month.

10. The method of claim 1, wherein tracking expenditures of the cardholder in the current month further comprises allowing all expenditures of the cardholder in a current month up to the monthly spending budget.

11. The method of claim 10, wherein tracking expenditures in the current month further comprises tracking expenditures of the cardholder in the current month against the monthly spending budget in each of the plurality of budget categories.

12. The method of claim 11, wherein tracking expenditures in the current month against the monthly spending budget in each of the plurality of budget categories further comprises tracking the expenditures in the current month against the monthly spending budget in each of the plurality of budget categories prioritized in the event a total spend of the cardholder for the current month exceeds the credit limit of the cardholder.

13. The method of claim 11, wherein tracking expenditures in the current month against the monthly spending budget in each of a plurality of budget categories further comprises notifying the cardholder when at total spend of the cardholder reaches a predetermined threshold.

14. The method of claim 11, wherein tracking expenditures in the current month against the monthly spending budget in each of a plurality of budget categories further comprises declining transactions that exceed the monthly spending budget for the current month.

15. The method of claim 14, wherein tracking expenditures in the current month against the monthly spending budget in each of a plurality of budget categories further comprises declining transactions based on the predetermined prioritization of the plurality of budge categories when a total spend of the cardholder for the current month exceeds the monthly spending budget.

16. The method of claim 1, wherein adjusting the monthly spending budget for the succeeding month when expenditures exceed the credit limit of the cardholder further comprises adjusting the spending budget by a shortfall amount according to the order of the predetermined prioritization of the plurality of budget categories.

17. The method of claim 16, wherein adjusting the spending budget by the shortfall amount according to the order of the predetermined prioritization of the plurality of budget categories further comprises adjusting the spending budget by the shortfall amount to accommodate category budgets in the order of the predetermined prioritization of the plurality of budget categories.

18. The method of claim 1, wherein adjusting the monthly spending budget for the succeeding month when expenditures exceed the credit limit of the cardholder further comprises adjusting the spending budget in each of the plurality of budget categories by a proportion of a shortfall in the absence of a predetermined prioritization.

19. The method of claim 18, wherein adjusting the spending budget in each of the plurality of budget categories by a proportion of a shortfall in the absence of a predetermined prioritization further comprises adjusting each of the plurality of budget categories by a percentage equal to the shortfall percentage.

20. A system for of managing cardholder spending on a transaction card account, comprising:
a processor coupled to memory, the processor being programmed to:
receive a monthly spending budget for a cardholder;
track expenditures of the cardholder in a current month against the monthly spending budget; and
adjust the monthly spending budget for a succeeding month when expenditures exceed a transaction card account credit limit of the cardholder, said adjustment being made according to an order of a predetermined prioritization of a plurality of budget categories or by a proportional amount in each of the plurality of budget categories in the absence of a predetermined prioritization.
